(19) United States
(12) Patent Application Publication
(10) Pub. No.: US 2026/0082093 A1
(43) Pub. Date: Mar. 19, 2026

(54) MONITORING STREAMING MEDIA CONTENT

(71) Applicant: EZDRM, Inc., Rye Brook, NY (US)

(72) Inventors: David C. EISENBACHER, Ossining, NY (US); Olga KORNIENKO, Yonkers, NY (US)

(73) Assignee: EZDRM, Inc., Rye Brook, NY (US)

(21) Appl. No.: 19/327,483

(22) Filed: Sep. 12, 2025

Related U.S. Application Data
(60) Provisional application No. 63/694,691, filed on Sep. 13, 2024.

(51) Int. Cl. H04N 21/239; H04L 65/65; H04N 21/83

(52) U.S. Cl. CPC H04N 21/2396; H04L 65/65; H04N 21/83

(57) ABSTRACT

Systems and methods disclosed herein in which at least a subset of segments of streaming media content, such as streaming video content, are signed with identifiers for provenance purposes. By signing the segments, the segments may be tracked to determine, among other things, whether the segments being streamed to a media player during a streaming session are being played by the media player, where the segments are being played, and/or whether the streaming session is an unauthorized streaming session as a result of a piracy activity.

### CROSS-REFERENCE TO RELATED APPLICATION[S]

This application claims priority to U.S. Provisional Patent Application Ser. No. 63/694,691, filed on Sep. 13, 2024, which is incorporated herein by reference in its entirety.

### FIELD

The present disclosure relates to streaming media content, in particular to, monitoring of streaming media content.

### BACKGROUND

Online streaming platforms, offering both live and on-demand video content, operate under complex business models governed by specific rules, including geographical playback restrictions and defined viewing periods. For example, live sporting events, such as baseball and basketball games, are often restricted from being streamed to certain geographic regions during certain periods. To uphold these restrictions, as well as to prevent other types of unauthorized access to media content, there's a pressing need for robust anti-piracy measures. Traditionally, this need has been met through Digital Rights Management (DRM) systems, supplemented by watermarking techniques (both visible and forensic) and technologies capable of detecting Internet Protocol (IP) addresses and Virtual Private Network (VPN) usage.

Currently the use of DRM, content delivery network (CDN) tokens, VPN detection software and Watermarking are the standardized methodology to enforce anti-piracy measures. In a media security framework, DRM is a prevention level technology combating illegal playback and capture of the content by an unauthorized user. VPN detection systems and session based unique CDN tokens are used to prevent content from being accessed before content can be played back. Each of these approaches to combat piracy has known limitations.

For example, due to device limitations, not every end device (e.g., a media player such as a smartphone, a tablet computer, a set-top box, a desktop or laptop computer, and so forth) used by a consumer is able to comply with DRM rules and enforce usages rights. As such, they can still be manipulated to capture content by bypassing conventional security mechanisms. It is also becoming increasingly more difficult to ensure accuracy of VPN detection. Along with the implementation of privacy laws obscuring the true IP of the device, along with privacy features of various platforms, such as ICLOUD PRIVATE RELAY, or other geolocation obfuscation technologies, have made this level of anti-piracy less effective. In addition, CDN tokens are vulnerable to hijacking and are sometimes disabled to reduce latency or improve user experience.

Watermarking, visible or forensics, is higher level security method used to track piracy after the fact for take downs and stream revocation. These efforts usually take about 30 minutes to be detected and shut down. The larger latency in this technique impacts both the current value of the content as well as the initial costs for protection on media companies.

While these methods have been somewhat effective in mitigating piracy, as noted above, they are not without flaws. The amount of time required to address and neutralize piracy threats is often unacceptably long. Furthermore, the widespread use of VPNs, the hijacking of content delivery network (CDN) tokens, and the unauthorized rebroadcasting of content have fueled an increase in piracy activities, posing challenges to content security and copyright enforcement.

Advertising-based content delivery faces similar challenges. The widespread adoption of ad-blocking technologies has notably disrupted revenue streams for advertising-based models, including Ad-supported Video on Demand (AVOD) and Free Ad-supported Streaming TV (FAST). Ad-blocking capabilities, once limited to browser extensions, have evolved to be incorporated into home routers, offering enhanced security and privacy. This evolution has led to difficulties in delivering ads on platforms outside traditional web browsers, such as smart TVs and native applications on various devices. Consequently, the mechanism to accurately monitor ad impressions through “ping” signals for played ads is being obstructed or manipulated at the network level within users' homes. This interference not only affects the pricing and placement fees of advertisements but also results in a downturn in overall advertising revenue.

As briefly noted, current ad-based technologies for determining whether a video ad played involves tracking certain signals or events known as “pings.” In the context of online advertising, these pings can include various tracking mechanisms and signals that are triggered when specific events occur during the playback of a video ad. With VAST and VPAID systems, there is communication between the ad server and video player. Browser based plug-ins, third party applications on a computer, tablet or smartphone can easily detect these ad server URL's and send false data or even block the communication entirely, thus, driving down the validity of the ad value. More robust technologies with Server-Side Ad Insertion (SSAI) do help to ensure that the ad is played, but the analytics and tracking via player event triggers are still subject to blocking. Ever increasing use of privacy protection within home network routers adding privacy features extends the ability to block ad markers not only on a per devices basis, but extends to all devices on the home network including smart televisions and other IP devices, thus making the ability to track whether ads are being played.

### SUMMARY

According to various implementations, streaming media content tracking (SMCT) systems and methods are disclosed herein in which at least a subset of segments of streaming media content, such as streaming video content, are signed with identifiers for provenance purposes and to ultimately track, among other things, whether the segments being streamed to a media player during a streaming session are being played by the media player, where the segments are being played, and/or whether the streaming session is an unauthorized streaming session. In some implantations, the SMCT methods may include receiving, from a media player, playback metrics in connection with streaming of a media content to the media player during a streaming session, the playback metrics including a streaming session identifier and media player location information; and determining whether the streaming session is an unauthorized streaming session by ascertaining whether a signing server of a content delivery network (CDN) used to stream at least a portion of the media content from the CDN to the media player during the streaming session is an appropriate signing server for signing and streaming the at least the portion of the media content from the CDN to the media player based on the media player location derived from the media player location information.

In some implementations, the playback metrics are received directly or indirectly from the media player in accordance with a Common Media Client Data (CMCD) standard.

In various implementations, receiving the playback metrics includes receiving a globally unique identifier (GUID) of the signing server used to sign and stream the at least the portion of the media content. For these implementations, the receiving the GUID may include receiving one or more respective GUIDs of one or more other signing servers used to sign and stream the at least the portion of the media content from a content origin to the media player. In some implementations, determining whether the streaming session is unauthorized includes determining whether the signing server and the one or more other signing servers are an appropriate combination of signing servers for signing and streaming the at least the portion of the media content to the media player.

In some implementations, the media content is video content such as video on demand (VOD), or a portion thereof, or the media content is live-stream video.

In some implementations, determining whether the signing server is an appropriate signing server for signing and streaming the at least the portion of the media content includes determining whether the signing server is last signing server of the CDN to sign and stream the at least the portion of the media content from the CDN to the media player, and if so, whether the signing server should be the last signing server of the CDN to sign the at least the portion of the media content based on the media player location.

In some implementations, the SMCT methods may further include executing a responsive action[s] if the streaming session is determined to be unauthorized. For these implementations, the responsive action[s] may include generating an alert or flag indicating that the streaming session is unauthorized, automatically terminating the streaming session, and/or recording the streaming session as an unauthorized session

In some alternative implementations, the SMCT methods may include tagging at least a subset of segments of media content being streamed via a content delivery network (CDN) and to a media player during a streaming session with a signing server identifier, wherein the signing server identifier is associated with a signing server of the CDN used to sign and stream the at least the subset of segments of the media content from the CDN to the media player; receiving, from the media player, playback metrics associated with the streaming of the media content during the streaming session, the playback metrics including a streaming session identifier, the signing server identifier, and media player location information; and determining whether the streaming session is an unauthorized streaming session by ascertaining whether the signing server is an appropriate signing server for streaming the at least the subset of segments of the media content from the CDN to the media player based, at least in part, on the media player location.

In some implementations, the segments are fragmented MP4 (fMP4) segments. In some implementations, tagging the at least a subset of segments of media content being streamed with the signing server identifier includes inserting the identifier into the payloads of the at least the subset of segments. In some implementations, tagging the at least a subset of segments of media content being streamed with the signing server identifier includes inserting the singing server identifier into a manifest of the media content.

In some implementations, tagging at least a subset of segments of media content with a signing server identifier includes tagging at least the subset of segments of the media content with a globally unique identifier (GUID) of the signing server. For example, in some implementations, tagging the at least the subset of segments of the media content with the GUID of the signing server includes inserting the GUID of the signing server into the subset of segments. In alternative or the same implementations, tagging the at least the subset of segments of the media content with the GUID of the signing server includes inserting the GUID of the signing server into a media content manifest.

In some implementations, tagging the at least the subset of segments of the media content with the GUID of the signing server includes tagging the at least the subset of the segments of media content with one or more GUIDs of one or more other signing servers, respectively, used to sign and stream the at least the subset of segments through the CDN. In some cases, tagging the at least the subset of the segments of media content with the GUID of the signing server and the one or more GUIDs of one or more other signing servers includes inserting the GUIDs of the signing server and the one or more other signing servers into the subset of segments. In some cases, tagging the at least the subset of the segments of media content with the GUID of the signing server and the one or more GUIDs of one or more other signing servers includes inserting the GUIDs of the signing server and the one or more other signing servers into a media content manifest.

In some implementations, tagging at least a subset of segments of media content being streamed during a streaming session with a signing server identifier includes tagging the signing server identifier to a first subset of segments of the steaming media content at a first frequency, and then tagging the signing server identifier to a second subset of segments of the steaming media content at a second frequency, wherein the first subset of segments are streamed to the media player before the second subset of segments, and wherein the first frequency is higher than the second frequency.

In some implementations, the at least a subset of segments of media content are tagged with a globally unique identifier (GUID) associated with the streaming session. In some implementations, the playback metrics are received in accordance with a Common Media Client Data (CMCD) standard.

In some implementations, receiving the playback metrics includes receiving a globally unique identifier (GUID) associated with the signing server used to sign and stream the subset of segments from the CDN to the media player. In some cases, receiving the GUID associated with the signing server includes receiving one or more GUIDs, respectively, of one or more other signing servers used to sign and stream the subset of segments through the CDN. In some cases, determining whether the streaming session is unauthorized includes ascertaining whether the signing server and the one or more other signing servers are an appropriate combination of signing servers for the streaming session based, at least in part, on the media player's location.

In some implementations, determining whether the signing server is an appropriate signing server includes ascertaining whether the signing server is last, among a plurality of signing servers of the CDN to sign the subset of segments before the subset of segments are streamed from the CDN to the media player, and if so, ascertaining whether the signing server should be the last signing server of the CDN to sign the subset of segments based, at least in part, on the location of the media player.

In various implementations, a computer-implemented method is disclosed for tagging a segment of media content being streamed via a content delivery network (CDN) and to a media player during a streaming session with a globally unique identifier (GUID) that associates the segment as corresponding to at least a portion of the media content; receiving, from the media player, playback metrics in connection with the streaming of the media content during the streaming session, the playback metrics including the GUID; and determining that the media content was played by the media player based, at least in part, on the reception of the GUID included in the playback metrics. In some cases, the media content is a movie, documentary, television program, live stream event, or advertisement.

In various implementations, a computer-implemented method is disclosed for tagging each of a plurality of segments of media content being streamed via a content delivery network (CDN) and to a media player during a streaming session with a respective globally unique identifier (GUID) that associates each segment as corresponding to a different portion of the media content; receiving, from the media player, playback metrics in connection with the streaming of the media content during the streaming session, the playback metrics including the GUIDs that were tagged to the plurality of segments; and determining that the media content was played by the media player based, at least in part, on the reception of the GUIDs included in the playback metrics.

In various implementations, a computer-implemented method is disclosed for receiving, from a media player, playback metrics in connection with streaming of media content to the media player during a streaming session, the playback metrics including a globally unique identifier (GUID) associated with a segment of the media content; and determining that the media content was played by the media player based, at least in part, on reception of the GUID included in the playback metrics.

In various implementations, a computer-implemented method is disclosed for receiving, from a media player, playback metrics in connection with streaming of media content to the media player during a streaming session, the playback metrics including a plurality of globally unique identifiers (GUIDs) respectively associated with a plurality of segments of the media content; and determining that the media content was played by the media player based, at least in part, on reception of the GUIDs included in the playback metrics.

### BRIEF DESCRIPTION OF THE DRAWINGS

FIG. 1 illustrates an example of how media content may be streamed to a media player via a content delivery network according to some implementations.

FIG. 2 illustrates a streaming media content tracking (SMCT) system in an example environment according to some implementations.

FIG. 3 is a flowchart of an example process for determining whether a media content streaming session is an unauthorized streaming session according to some implementations.

FIG. 4 is another flowchart of another example process for determining whether a media content streaming session is an unauthorized streaming session according to some implementations.

FIG. 5 is a flow chart of an example process for determining whether a media content was played by a media player according to some implementations.

FIG. 6 is a flow chart of another example process for determining whether a media content was played by a media player according to some implementations.

FIG. 7 is a flow chart of another example process for determining whether a media content was played by a media player according to some implementations.

FIG. 8 is a flow chart of another example process for determining whether a media content was played by a media player according to some implementations.

FIG. 9 is a high-level block diagram of an example computing device according to some example embodiments.

### DETAILED DESCRIPTION

According to various implementations of the present disclosure, streaming media content tracking (SMCT) systems and methods are disclosed herein in which at least a subset of segments of streaming media content, such as streaming video content, are signed with identifiers for provenance purposes and to ultimately track, among other things, whether the segments being streamed to a media player during a streaming session are being played by the media player, where the segments are being played, and/or whether the streaming session is an unauthorized streaming session (e.g., as a result of a piracy activity) based, at least in some cases, on the provenance (e.g., origin or historical) information associated with the segments.

In various implementations, the identifiers that ac used to sign the segments may be globally unique identifiers (GUIDs), such as GUIDs to identify the segments, the streaming session, and signing servers used to sign the segments during their delivery to their destination as will be further described herein. In some cases, the GUIDs, such as the GUID of a media content segment may be generated by performing a hashing operation to generate a digest, which may be used as the GUID. To facilitate signing of the at least the subset of the segments of the streaming media content, the SMCT systems and methods may employ a number of signing servers that are each paired with a CDN server and that are configured to sign at least the subset of the segments of the streaming media content as will be further described herein. Thus, as segments of a media content is routed through a CDN via CDN servers and their respective signing server during a streaming session, the segments are signed by the respective signing servers of the CDN servers along their CDN delivery path. Further, upon a media player, such as the media player of a piracy actor, receiving and playing the media content, the media player will send to the SMCT system providence information, such as the GUIDs of the signing servers that signed the media content segments in accordance with, for example, the Common Media Client Data (CMCD) standard. By checking to see if the signing servers are the appropriate signing servers to sign the segments based, at least in part, on the location of the media player, a determination may be made as to whether the streaming session is an authorized streaming session.

As used herein, a segment of media content may be in reference to a small, self-contained part of a video or audio stream. Conventional segments are typically a few seconds in duration. An example of a segment is a fragmented MP4 (fMP4) container.

In some implementations, the SMCT systems and methods may be implemented at least partly in a content delivery network (CDN) operating in accordance with Coalition for Content Provenance and Authenticity (C2PA) and Common Media Client Data (CMCD) standards. As is well-known, a CDN is a network of geographically distributed servers that work together to efficiently deliver media content to, for example, geographically dispersed media players of users. The media content to be streamed via CDN may be video on demand (VOD) or live streaming video. Typically, a CDN will cache content, to temporarily store in CDN servers, copies of media files, close to users so that they can access content more quickly. Even with live streaming video, the CDN servers may cache the streaming media as there is generally a small amount of latency even in live streaming. Note that in the following, these CDN servers used to cache and stream media content may be referred to herein as “edge workers” since depending on the location of a user (e.g., the media player of the user), any one of these edge workers (CDN servers) can be the last “edge” CDN server in the CDN to stream the media content from the CDN to the media player. That is, it is generally preferable that the edge worker that is nearest (e.g., nearest in terms of geographic proximity, network topology, or routing efficiency) to the user's media player is the edge worker used to stream the media content from the CDN to the media player. However, it has been determined that when media content is being pirated, the piracy actor will often use an inappropriate edge worker that is not the closest edge worker to the media player location for streaming from the CDN to the media player in an effort to cloak the location of the actor's media player. Piracy actors may also route streaming media in an usual route (e.g., using servers that would not be logical based on the specific circumstances such as the location of the media player) within the CDN in an effort to disguise their activities.

According to various implementations, only a subset of segments of streaming media may be signed. That is, the frequency or percentages of the segments of a streaming media content to be signed can be adjusted upwards or downwards depending on the goals of the signing operations. For example, in some implementations, increasing the frequency of signed segments may aid in faster detection of unauthorized streaming activity. For example, by signing every second or third segment at the beginning of a stream, additional data points are generated in a shorter time window, thereby enabling earlier identification of potential piracy. Of course, increasing the frequency in which segments are signed and subsequently processed may have drawbacks, such as increasing latency and computational requirements. In some implementations, the frequency in which streaming segments are signed may be increased for high value portions of the streaming media content. For example, for live streaming sporting events, such as a football game, the ending of the game in some cases may be considered high-valued, and therefore, the frequency in which segments are signed may be increased at the end of the game.

In various implementations, to perform the various functionalities to be described herein, each signing server may be paired with and located at or near the location of an edge worker (i.e., CDN server) of the CDN. For example, in some implementations, an edge worker and a respective signing server may be virtual servers implemented on a single computing device executing computer-readable instructions (e.g., software). The signing servers may be used to sign at least a subset of segments of media content being streamed to a media player, with GUIDs before the segments are streamed from the CDN to the media player. As will be further described herein, each segment to be signed may be signed with one or more GUIDs.

For example, as a media content segment is being routed through multiple edge workers and their respective signing servers of the CDN, the segment may be signed by each signing server along its route (e.g., delivery path) with a unique identifier (e.g., a GUID) associated with the respective signing server. As a result, as a segment treks through the CDN, multiple signing servers may sign the segment with their GUIDs that may be used to identify the last or “edge” signing server to sign the segment before it exits the CDN and to the media player. Thus, at least a subset of the segments of a media content being streamed through the CDN may be signed with the respective GUIDs associated with each signing server used to sign and stream the segments from a content source or origin and through the CDN.

In some cases, a segment may also be signed with other GUIDs that may be used to, among other things, identify the media content that the signed segment belongs to, identify the part of the media content the segment belongs to, and identify which streaming session does the segment comes from. For example, identifying whether the segment is part of a particular VOD, a live stream, or ad, and which part of the VOD, live stream, or ad the segment belongs to.

More particularly, the signing of a segment of a media content may entail cryptographically associating the segment with provenance metadata, including unique identifiers (e.g., GUIDs) for the segment, the streaming session, and the signing servers that signed the segment as it treks through the CDN. The association or tagging of such identifiers may be performed by a content source for the media content and each signing server along the CDN route that the segment takes through the CDN. Because a segment may traverse multiple CDN servers during its relay from content source to the media player, multiple GUIDs may be associated with a single segment. Association of a GUID may be implemented using different approaches as will be discussed in greater detail herein.

For example, in some implementations, a manifest-based association may be employed. In a manifest-based association, each segment of a media content is independently hashed, and the resulting digest (e.g., GUID) is recorded in a manifest of the media content that is compliant with the C2PA standard. For these implementations, the manifest may include provenance assertions such as segment identifier, identifiers for one or more signing servers, and streaming session identifier. These identifiers may be in the form of GUIDs. The manifest may be digitally signed, creating a cryptographic binding between the segment and its provenance record.

In the same or alternative implementations, a direct insertion approach may be additionally or alternatively employed that inserts the GUIDs directly into the segments. In some cases, GUIDs may be inserted into the payload of the segment itself (e.g., within the mdat box), allowing the segment to carry its own provenance reference. This method may be used in conjunction with manifest-based binding to support redundancy and independent validation

As noted above, the CDN to be employed may operate in accordance with C2PA, which is a standard that ensures the integrity of a streaming media by including into each media file, such as a media content segment, a digital fingerprint (e.g., provenance information of the media content) that allows the tracing the origins of the media content. In addition, the C2PA standard allows association of additional data/information to media content segments including, for example, GUIDs of respective signing servers used to sign and stream the segments, and the GUIDs of the streaming session and the segment itself.

In contrast to the C2PA standard, the CMCD standard is an open standard developed by the Consumer Technology Association designed to enhance the interaction between media players and content delivery systems. By allowing a media player to transmit back to the CDN detailed playback information, including custom data points for real-time analytics of video and audio content at the object level, the CMCD standard allows streaming platforms to fine-tune and regulate content delivery more effectively. Examples of playback metrics that can be sent back to the CDN under the CMCD standard includes bitrate, buffer length, content ID, measured throughput, object playback duration, playback rate, and session ID. Such metrics may be used to manage/tweak the streaming of the media content from the CDN to the media player. CMCD also allows additional data to be transmitted back to the CND in addition to standard playback metrics.

For example, in various implementations, a media player that receives from a CDN a media content segment signed with (e.g., inserted into the segment or into the media content manifest) a first GUID (identifying the last signing server used to sign and stream the segment from the CDN to the media player) and a second GUID (identifying the segment itself) can be prompted under the CMCD specification to send back to the CDN, as well as to other destinations, the first and second GUID. Such information may be useful in determining whether the streaming session used to stream the segment is an unauthorized streaming session (e.g., act of piracy) and/or to determine that the media content associated with the segment was played by the media player as will be discussed in greater detail herein. Also, the segment may be signed with other GUIDs associated with other aspects/features of the media content streaming in various alternative implementations.

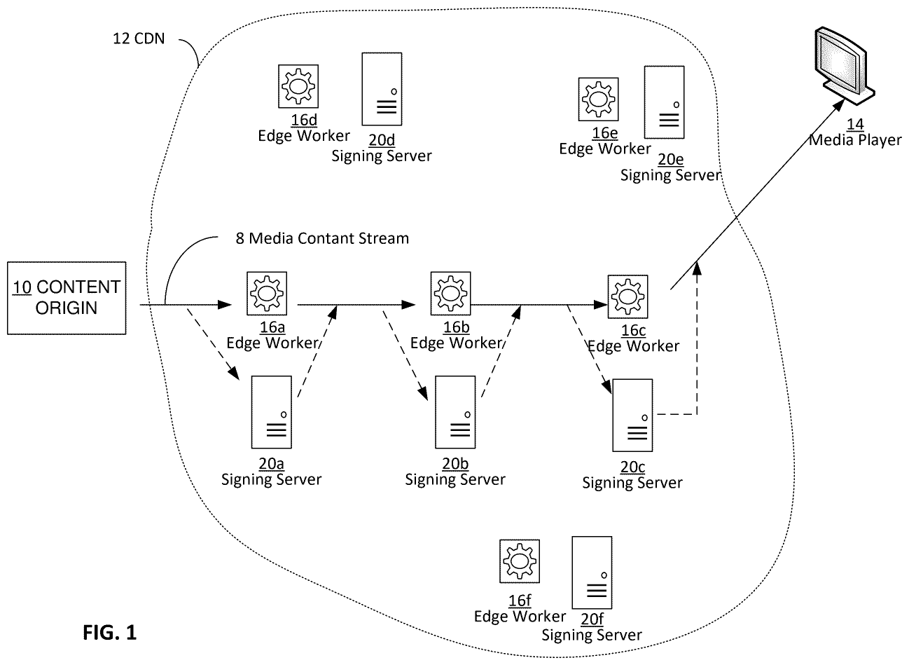

FIG. 1 illustrates an example of how media content may be streamed to a media player via a content delivery network according to some implementations. More particularly, FIG. 1 illustrates an example scenario of how, during a streaming session, media content may be streamed to a media player through a CDN using multiple edge workers (i.e., CDN servers) and signing servers according to some implementations. In the example scenario illustrated in FIG. 1, media content stream 8 is being streamed through the CDN 12 from a content origin 10 to a media player 14, which is associated with a piracy actor. That is, the streaming of the media content stream 8 illustrated in FIG. 1 is as a result of a piracy act. Note that for purposes of the following description, the media content stream 8 may also represent the CDN delivery path that the media content stream takes to stream through the CDN.

The CDN 12 includes a plurality of edge workers 16a, 16b, 16c, 16d, 16e, and 16f, which are CDN servers for streaming media content. Note that in the following, “*” represents a wildcard. Thus, references in the following description to, for example, an “edge worker 16*” may be in reference to edge worker 16a, edge worker 16b, edge worker 16c, edge worker 16d, edge worker 16e, or edge worker 16f. Although only a few edge workers are depicted in FIG. 1, in reality, the CDN 12 may include thousands, and perhaps hundreds of thousands or more edge workers. For case of illustration, however, only six edge workers 16a, 16b, 16c, 16d, 16c, and 16f are illustrated herein.

According to various implementations, each edge worker 16* may be paired with a respective signing server 20a, 20b, 20c, 20d, 20c, and 20f. Further, each edge worker 16* may be located in the vicinity of or at the location of their respective edge worker 16*. Each signing server 20* may be used to sign (with identifiers such as GUIDs) at least a subset of the segments of a media content being streamed to the media player 14. For example, in FIG. 1 a subset of the segments of the media content stream 8 being streamed to edge worker 16a, and before the edge worker 16a has an opportunity to process/parse the subset of the segments, may be routed/directed by the edge worker 16a to the signing server 20a for signing of the subset (e.g., sign every fourth or fifth segment) with, for example, a GUID associated with or identifying signing server 20a. Note that although in the implementation illustrated in FIG. 1, the subset of the segments of the content media stream 8 are depicted as being directed or routed by the edge worker 16a to the signing server 20a therefore bypassing any processing/parsing by edge worker 16a, in alternative implementations, the subset of the segments may be pulled from the content media stream 8, signed by the signing server 20a, and then placed back into the media content stream 8 entirely just before or entirely just after the content media stream 8 is streamed through the edge worker 16a without bypassing the edge worker 16a.

As a selective subset of the segments of a streaming media content travels through the CDN, they may be signed by each signing servers (e.g., signing servers 20a, 20b, and 20c of FIG. 1) along the CDN route that the media content stream 8 takes. In various implementations, a segment of a media content stream 8, while traveling along its CDN route (i.e., delivery path), may be signed by each of the signing server 20a, 20b, and 20c when each of the signing servers 20a, 20b, and 20c tags the segment with one or more GUIDs. In various implementations, a signing server 20a, 20b, or 20c may tag the one or more GUIDs to the segment by alternative means. For example, in some cases, the one or more GUIDs may be tagged to the segment by inserting the one or more GUIDs in the segment. Alternatively, the one or more GUIDs may be tagged to the segment by inserting the one or more GUIDs into a manifest of the media content (e.g., VOD, live streaming media, etc.).

In the example illustration of FIG. 1, edge worker 16c is the last CDN edge worker used to stream the media content stream 8 from the CDN 12 to the media player 14. However, based on the relative location of the media player 14 with respect to the edge workers 16* of the CDN 12, edge worker 16e should be the last CDN edge worker used to stream the streaming media content 8 to the media player since edge worker 16e is closest to the media player 14. In the scenario illustrated in FIG. 1, the piracy actor associated with media player 14 is using other edge workers 16a, 16b, and 16c to stream the streaming media content 8 to the media player 14 to cloak the piracy activity. Alternatively, the piracy actor rather than causing the media content to stream through multiple pairs of edge workers 16a, 16b, and 16c, and signing servers 20a, 20b, and 20c, may only stream the media content through a single edge worker/signing server pair (e.g., the edge worker 16c and the corresponding signing server 20c) to stream to the media player 14.

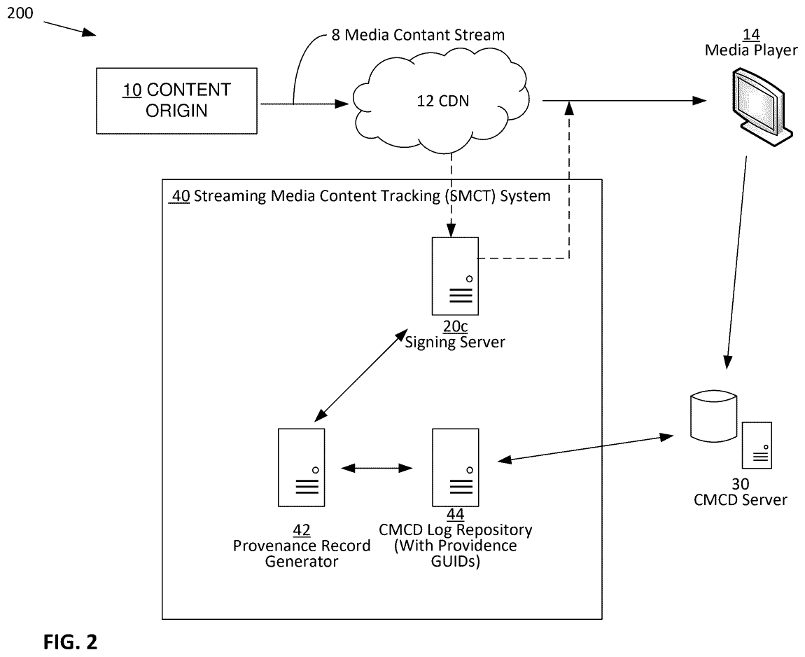

As will be further described herein, by having each of the signing server 20a, 20b, and 20c sign at least the subset of the segments of the media content stream 8 being streamed during a streaming session to the media player 14 with their respective GUIDs (e.g., In FIG. 1, the three GUIDs respectively associated with the three signing servers 20a, 20b, and 20c), the streaming media content tracking (SMCT) systems and methods may be able to determine that the streaming session in which the media content is being streamed is unauthorized. That is, the media player 14 upon receiving the subset of the segments (e.g., signed segments) of the media content stream 8 may transmit such information (e.g., the GUIDs of the signing servers 20a, 20b, and 20c used to sign the subset of the segments and tagged to the subset of the segments of the media content) back to the CDN and to a SMCT system 40 (see FIG. 2) in accordance with the CMCD standard. The SMCT system 40 can then take the received information and review the location of the media player 14, among other things, to determine whether the streaming session was an unauthorized piracy activity. For example, in some implementations, by ascertaining that the signing server 20c was the last signing server used to sign and stream the subset of segments of the media content from the CDN 12 to the media player 14 rather than the signing server 20c, which is closer to the media player 14, a determination may be made that the streaming session was unauthorized.

In some alternative implementations, rather than looking or checking only at the last signing server 20c used to sign and stream at least the subset of the segments of the media content from the CDN 12 to the media player 14, the SMCT system 40 may look at all the signing servers 20a, 20b, and 20c used to sign (with their GUIDs) and stream the subset of the segments of the media content stream to determine whether the streaming session was unauthorized. That is, if there is no logical reason for using the specific combination of the signing server 20a, 20b, and 20c in the specific order to sign and stream the subset of the segments of the media content, then this may be a strong indication that the corresponding stream session is unauthorized. For example, if multiple signing servers 20* that are not geographically related are used such that the media content being streamed must take a crisscrossing path to be streamed to the media player 14, then this may indicate that the associated streaming session is unauthorized.

In various implementations, a signing server 20* may sign a segment of media content with one or more GUIDs including a GUID that is linked with or identifies the signing server 20* itself by either inserting the one or more GUIDs into the segment, such as in the payload of the segment, or inserting the one or more GUIDs into a manifest for the media content. Note that although a media content segment may be tagged with one or more other GUIDs other than the GUIDs of the signing servers 20* that signs the segment, at least some of the other GUIDs that are tagged to the segment may have been tagged by other network players/systems. For example, the content origin 10 of FIG. 1 may tag the media content segments with GUIDs that identifies which media content that the segments belongs to, GUIDs that identifies where in the media content the segments belong to, and other GUIDs that provides provenance information. Alternatively, such GUIDs may be signed or tagged to the segments by one or more of the signing servers 20*, such as signing server 20a the first signing server in the CDN 12 to sign a segment.

As noted above, the frequency of the segments of a streaming media content to be signed may be adjusted depending on various factors. For example, in some implementations, increasing the frequency of signed segments may aid in faster detection of unauthorized streaming activity. For instance, by signing every second segment at the beginning of a stream, additional data points are generated in a shorter time window, thereby enabling earlier identification of potential piracy. Subsequently, the frequency at which the segments are signed may be throttled down later on to reduce latency and computational load.

In some implementations, the signing frequency may be dynamically adjusted based on the value of the content or contextual factors. For instance, at the start of a live sporting event—when the content carries heightened commercial value—the SMCT system may increase the frequency to every other segment to enable faster detection and mitigation. During lower-value periods, such as halftime or mid-game intervals, the frequency may be reduced to every 30th or 100th segment, conserving resources while maintaining coverage. This ability to dynamically adjust the signing interval allows the system to balance efficiency with heightened protection during periods of greater risk.

FIG. 2 illustrates a streaming media content tracking (SMCT) system 40 in an example environment 200 according to some implementations. More particularly, the example environment 200 includes the same CDN 12, content origin 10, and the media player 14 illustrated in FIG. 1. For the implementations, the example environment 200 includes the SMCT system 40, the content origin 10, the CDN 12, the media player 14, and a CMCD server 30. Note that SMCT system 40 and the CMCD server 30 may be part of the CDN 12. However, for illustrative purposes, the SMCT system 40 and the CMCD server 30 are depicted outside of the CDN 12. Similarly, for case of illustration and illustrative purposes only, the SMCT system 40 is depicted as including only a single signing server 20c of FIG. 1, but in reality, may include numerous signing servers 20* that may each be paired with a respective CDN server (i.e., edge worker) 116* of the CDN 12.

The SMCT system 40 may include a provenance record generator 42, an MCD log repository 44 (with providence GUIDs), and a plurality of signing servers 20*. In brief, the provenance record generator 42 may generate GUIDs for associating with and identifying various items and features including the signing servers 20* used to sign media content segments during a streaming session, the media content segments themselves, the media content source, and so forth, while the CMCD log repository 44 in some implementations may, among other things, ascertain which signing server 20* is the last or edge signing server used to sign and stream at least a subset of segments of a media content from the CDN 12 to the media player 14, and based at least in part on this determination, determine whether a streaming session is unauthorized.

In various implementations, the GUIDs generated by the provenance record generator 42 may correspond to Coalition for Content Provenance and Authenticity (C2PA) provenance records, and in some implementations, the manifest of, for example, a media content may include binding metadata such as streaming session identifiers, signing server assignments, segment identities, and related metadata, thereby cryptographically associating each segment with its provenance record. The SMCT system 40, via CMCD log repository 44, may determine whether a session is unauthorized based on deviations in these bindings and, in response, execute a responsive action including generating an alert, recording the session as unauthorized, or automatically terminating the session.

The provenance record generator 42 may be configured to generate C2PA provenance records in the form of globally unique identifiers (GUIDs). These provenance records uniquely associate and identify components of the system, including signing servers 20*, individual media content segments, streaming sessions, and related metadata. Each GUID thus operates as a verifiable provenance record embedded into the media supply chain.

The manifest associated with the content may include binding metadata that references these C2PA provenance records. Such binding metadata may include, for example, streaming session identifiers, signing server assignments, segment identities within the content sequence, and contextual information required to verify authenticity. By embedding the binding metadata into the manifest, each signed segment is cryptographically bound to its corresponding provenance record, ensuring traceability and enabling independent validation at the segment level.

The CMCD log repository 44 may store and correlate the C2PA provenance records (GUIDs) with playback metrics reported from the media player 14 in accordance with the CMCD standard. By comparing the received GUIDs against provenance records generated by the provenance record generator 42 and the binding metadata in the manifest, the CMCD log repository 44 may determine which signing server 20* acted as the last or “edge” signing server responsible for signing and delivering at least a subset of the segments of the media content from the CDN 12 to the media player 14. This process establishes a cryptographically verifiable chain of custody for each signed segment.

Based at least in part on this determination, the SMCT system 40 may evaluate whether the signing server assignment and manifest bindings are geographically and logically appropriate for the media player's location. If the assignment deviates from the expected path—such as use of a non-proximal signing server, tampering with C2PA provenance records, or alteration of manifest metadata—the session may be determined to be unauthorized, thereby indicating a piracy attempt. In such cases, the SMCT system 40 may execute a responsive action, including generating an alert, recording the session as unauthorized for forensic review, and/or automatically terminating the streaming session.

In some implementations, the GUIDs tagged to the media content segments received by the media player 14 during the streaming session may be reported back to the SMCT system 40 as part of playback metrics in accordance with CMCD standard. In various implementations, included in the playback metrics to be received by the SMCT system 40 is the Internet Protocol (IP) address of the media player 14.

In some implementations, the media player location information may be derived from the IP address of the device, which can be used to approximate the geographic or network topographical location of the media player 14, to validate that the signing server 20* that was last to sign the segments is regionally appropriate, and to detect anomalies in server assignment. However, the accuracy of IP-based location information may be affected by obfuscation mechanisms such as VPN tunneling, proxy services, carrier-grade NAT, or privacy-enhancing technologies such as iCloud Private Relay. Accordingly, deviations between the expected signing server based on the player's reported location and the actual signing server identified by the GUIDs may be treated as a strong indicator of an unauthorized streaming session or an attempt to disguise piracy activity.

To facilitate understanding of the functionalities of the SMCT system 40, the SMCT system 40 and its components will be described herein in the context of the scenario described above with respect to FIG. 1. More particularly, a media content (e.g., media content stream 8) to be streamed to the media player 14 may be initially provided by the content origin 10 and may be streamed to the media player 14 via the CDN 12. As the media content stream 8 flows through the CDN 12, the signing server 20c (which is paired with and located at or in the vicinity of edge worker 16c that is the last edge worker of the CDN 12 to stream the media content stream 8 from the CDN 12 to the media player 14) pulls selective segments from the media content stream 8, signs each of the selective segments with one or more GUIDs (e.g., a GUID identifying the signing server 20c), and then inserts the signed segments back into the media content stream 8 for streaming from the CDN 12 to the media player 14.

As noted above, the media player 14, upon receiving and playing the signed segments of a media content stream, transmits to a CMCD server 30 playback metrics associated with the streaming of the media content stream 8 and the playback of the media content in accordance with CMCD standard. The CMCD standard allows additional metrics/information to be sent to the CMCD server 30 in addition to conventional playback metrics. According to various implementations, the media player 14 may also send to the CMCD server 30, in addition to conventional playback metrics, the one or more GUIDs associated with each of the signed segments received by the media player 14 including, for example, a GUID identifying the edge signing server (e.g., the signing server 20c) that was the last signing server to sign the signed segments before the signed segments were streamed to the media player 14, as well as other GUIDs of other signing servers (e.g., signing servers 20a and 20b) that signed or tagged the segments streamed to the media player 14. As noted above, a GUID may be associated with a segment by inserting the GUID into the segment, or into a manifest of the media content that the segment belongs to.

In some implementations, the media player 14 may send to the CMCD server 30, the GUIDs of all the signing servers (e.g., signing servers 20a, 20b, and 20c) of the CDN 12 used to sign and stream at least a subset of the segments of a media content through the CDN and to the media player 14. In some cases, the media player 14 may send to the CMCD server 30, the GUIDs that identifies the signed segments streamed to the media player 14. Other GUIDs of other aspects of the media content streaming may also be associated with (e.g., tagged to) the signed segments received by the media player 14, and upon receipt by the media player 14, may also be sent to the CMCD server 30 by the media player 14 in various alternative implementations. The other GUIDs, such as the segment identifier, media content identifier, and so forth, may be tagged to the segments by the content origin 10 or by one of the signing servers 20*. In brief, the CMCD server 30, which is part of the CDN 12, may use the conventional playback metrics to, among other things, make adjustments to the streaming of the media content to the media player 14.

In various implementations, a copy of the playback metrics provided to the CMCD server 30 including the conventional playback metrics (e.g., bitrate, buffer length, content ID, measured throughput, object playback duration, playback rate, session ID, etc.) and the GUIDs tagged to the signed media content segments received by the media player 14 may be provided to the CMCD log repository 44 of the SMCT system 40. Note that the CMCD log repository 44 may include providence GUIDs (e.g., the GUIDs of, of example, the signing servers 20* of the CDN 12 used to sign the signed segments as well as the GUIDs of streaming media content segments) provided by the provenance record generator 42.

In various implementations, the CMCD log repository 44 may maintain a lookup table/database that includes GUIDs provided by the provenance record generator 42 and what they relate to (e.g., GUIDs for identifying specific signing servers 20*, GUIDs that identifies specific segments, and so forth). In various implementations, the CMCD log repository 44 may look up the GUIDs included in the received playback metrics, and based on the providence information provided by the provenance record generator 42, ascertain what the GUIDs relate to (e.g., identifying the edge or last signing server 20c used to sign and send the signed segments from the CDN 12 to the media player 14 and/or the identities of the signed segments including what part of a video file, such as a movie, live video, or an Ad, does the signed segments belongs to).

In some implementations, the SMCT system 40 may determine that a streaming session used to stream segments of a media content to the media player 14 was unauthorized based on the identity of the last signing server (e.g., signing server 20c) to sign and stream the segments of the media content from the CDN 12 to the media player 14. Alternatively, the determination of an unauthorized streaming session may be based on the identities of the specific combination of the signing servers (e.g., signing servers 20a, 20b, and 20c) used to sign and stream the signed segments, and in some cases, based on the order in which they signed the segments.

As segments of a media content is routed/delivered through the CDN 12 during a streaming session, multiple signing server 20 along the CDN delivery path, such as signing servers 20a, 20b, and 20c in the example scenario illustrated in FIG. 1, may sign the segments. In some embodiments, the signing of the segments may be by tagging the segments with their identifiers (e.g., their respective GUID). As noted above, in some implementations, to determine whether the streaming session is unauthorized, the SMCT 40 may need to identify the last signing server (e.g., signing server 20c in the illustrated example of FIG. 1) to sign and stream the segments before the segments exit the CDN 12 and is streamed to the media player 14.

In various implementations, the SMCT system 40 may be configured to determine which signing server along the delivery path of a media content is the last signing server to sign a segment before it left the CDN 12. In some implementations, each signing server 20* along the delivery path tags its own identifier (GUID) as part of the C2PA provenance metadata into the segment or the manifest. As a result, a segment that traverses multiple signing servers 20* may carry a chain of identifiers corresponding to each signing server 20* it passed through. The CMCD log repository 44 may then evaluate this sequence of identifiers and based on their order, determine which signing server 20* was the final (edge) signing server responsible for signing the segment immediately prior to delivery to the media player 14.

In some implementations, the provenance information may explicitly include an “edge signing server” identifier that designates the final signing server. In other implementations, the SMCT system 40 determines the last signing server by the position of the identifier in the signing chain or by cross-referencing with the manifest metadata, which encodes the expected order of signing. This is important because the last signing server provides the point of final trust and geographic proximity validation—if the final server does not match the expected “nearest” or appropriate server for the player location, the streaming session may be determined to be unauthorized.

In the illustrated embodiment of FIG. 1, the segment of the media content being streamed through the CDN 12 passes sequentially through signing server 20a, signing server 20b, and signing server 20c, with each server adding its identifier into the provenance record. The CMCD log repository 44 receives playback metrics from the media player 14, including the ordered sequence of signing server identifiers. Based on this sequence, the CMCD log repository 44 is able to determine that signing server 20c was the final (edge) signing server responsible for signing and delivering the segment immediately prior to playback. This determination provides cryptographically verifiable assurance of the segment's origin and path through the CDN 12 and further enables the SMCT system 40 to evaluate whether the signing path was appropriate for the session (e.g., nearest edge, correct geographic region, no tampering).

Under the C2PA specification, each identifier (GUID) is not simply recorded but is cryptographically bound to the asset. In various implementations, this may be achieved by hashing the identifier and embedding it within the manifest, followed by signing the manifest with the signing server's private key. Each successive signing server appends its own signed entry, producing a layered chain of signatures. This ensures that:
The provenance records cannot be altered or reordered without invalidating the signatures.
The last valid signature in the chain uniquely identifies the edge signing server.
Independent validation tools can reconstruct the signing sequence and confirm authenticity even outside the playback environment.

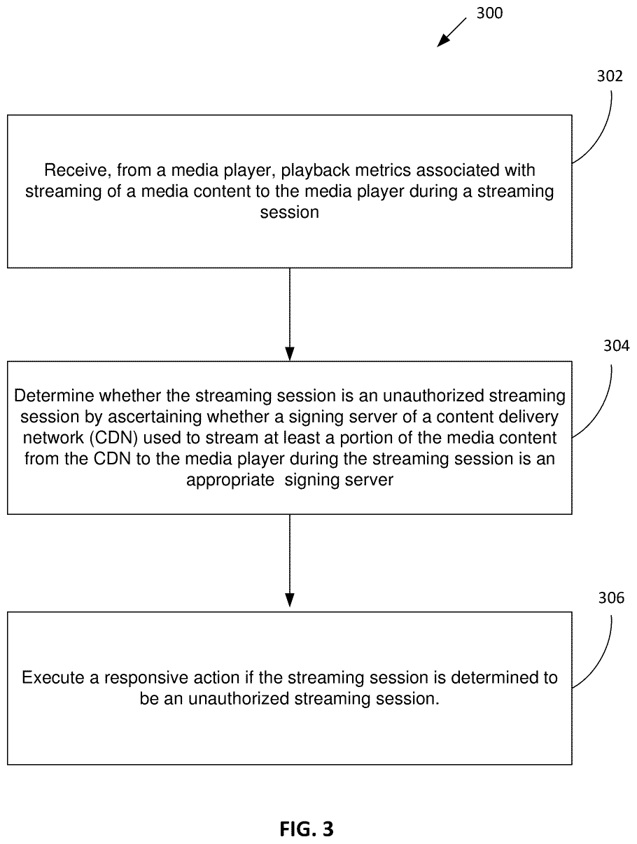

FIG. 3 is a flowchart of an example process 300 for determining whether a media content streaming session is an unauthorized streaming session according to various implementations. In some implementations, at least some of the operations illustrated in FIG. 3 may be performed by a streaming media content tracking (SMCT) system, such as the SMCT system 40 of FIG. 2. For case of illustration and to facilitate understanding of process 300, the following discussion of process 300 will reference the systems and features illustrated in FIGS. 1 and 2. However, those of ordinary skill in the art will recognize that process 300 may be implemented using systems and features other than those illustrated in FIGS. 1 and 2.

In various implementations, process 300 may begin when a reception operation 302 is performed for receiving, from a media player, playback metrics in connection with streaming of a media content to the media player during a streaming session, the playback metrics including a streaming session identifier and media player location information. For instance, the SMCT system 40 of FIG. 2 receiving directly or indirectly, from a media player 14, playback metrics (e.g., conventional playback metrics including bitrate, buffer length, content ID, measured throughput, object playback duration, playback rate, session ID, as well as a GUID of at least the last or edge signing server 20c used to sign and stream signed segments of media content being streamed and/or GUIDs for the signed segments of the media content stream 8 being streamed) in connection with streaming of a media content to the media player 14 during a streaming session, the playback metrics including a streaming session identifier (e.g., a GUID associated with the streaming session) and media player location information (e.g., IP address).

Process 300 may also include a determination operation 304 for determining whether the streaming session is an unauthorized streaming session by ascertaining whether a signing server of a content delivery network (CDN) used to stream at least a portion of the media content from the CDN to the media player during the streaming session is an appropriate signing server for signing and streaming the at least the portion of the media content from the CDN to the media player based on the media player location derived from the media player location information. For instance, the SMCT system 40 of FIG. 2 determining, by the SMCT system 40, whether the streaming session (which may involve streaming of a live event, a VOD, an ad or commercial, and so forth) is an unauthorized streaming session (e.g., act of piracy) by ascertaining by the SMCT system 40, whether a signing server 20c of a CDN 12 used to stream at least a portion (e.g., selective segments) of the media content from the CDN 12 to the media player 14 during the streaming session is an appropriate signing server for signing and streaming the at least the portion of the media content (e.g., media content stream 8 of FIGS. 1 and 2) from the CDN 12 to the media player 14 based on the media player location derived from the media player location information (e.g., IP address). That is, in some cases, the IP address of the media player 14 can be used to approximate the geographic location of the media player, validate that the signing server used to sign and stream at least a portion of the media content from the CDN 12 to the media player 14 is regionally appropriate, and detect anomalies in server assignment. However, the accuracy of IP-based location information may be affected by obfuscation mechanisms such as VPN tunneling, proxy services, carrier-grade NAT, or privacy-enhancing technologies such as iCloud Private Relay. Accordingly, deviations between the expected signing server based on the media player's reported location and the last signing server of the CDN 12 that signed and streamed at least a portion of the media content may be treated as a strong indicator of an unauthorized streaming session or an attempt to disguise piracy activity.

In some implementations, a signing server, such as the signing server 20e of FIG. 1, may be ascertained to be the appropriate signing server for signing and streaming media content segments from the CDN 12 to a media player 14 if the signing server 20e is nearest to the location of the media player 14, relative to the other signing servers 20* of the CDN 12. As used herein, “nearest” refers to the most appropriate signing server 20* for a given media player 14 based on geographic and/or network proximity. In some embodiments, “nearest” may correspond to the signing server 20* that is physically closest in geographic location to the media player.

In other embodiments, “nearest” may be determined by network topology or routing efficiency, such as the signing server providing the lowest measured latency, hop count, or throughput delay relative to the media player. Thus, the “nearest” signing server is not limited to strict geographic distance, but instead, encompasses the signing server 20 paired with the edge worker 16* that would ordinarily be selected by the CDN 12 to provide the most efficient and regionally appropriate delivery of media content to the media player 14 under legitimate operating conditions. In some embodiments, the use of a signing server 20* paired with the edge worker 16* that is not the nearest to the media player 14 may be indicative of an attempt to cloak the true location of the player or otherwise disguise piracy activity. For example, a piracy actor may deliberately route requests through a distant or inappropriate edge worker to obscure their actual location. Detection of such deviations from the expected “nearest” server assignment may therefore be treated as strong evidence of an unauthorized streaming session.

In some implementations, a signing server 20* may sign at least a portion of the media content by tagging each of at a subset of segments of the media content with one or GUIDs including a GUID associated with the respective signing server 20*. For example, in the illustrated example of FIG. 2, each signing server 20a, 20b, and 20c along the CDN delivery route that the media content stream 8 takes through the CDN 12 will sign or tag at least the subset of segments of the media content stream 8 with their respective GUID. Thus, in the example of FIG. 1, the subset of segments of the media content stream 8 to be streamed to the media player 14 will be signed with the three respective GUIDs of the three signing servers 20a, 20b, and 20c along the CDN route. Additionally, other GUIDs related to, for example, providence information, such as the source identifier, segment identifier, and so forth, may be tagged to the subset of segments of the media content stream 8 by, for example, the content origin 10, or by one of the signing servers 20* such as signing server 20a, which in the scenario illustrated in FIG. 1 was the first signing server to sign the segments.

In some implementations, process 300 may additionally include an execution operation 306 for executing a responsive action if the streaming session is determined to be an unauthorized streaming session. For instance, the SMCT system 40 of FIG. 2 executing a tracking (e.g., recording or flagging that the streaming session is unauthorized) or responsive action (e.g., terminating the streaming session) if the streaming session is determined to be an unauthorized streaming session.

In various implementations, process 300 may further include an execution operation 306 for executing a responsive action if the streaming session is determined to be unauthorized. For instance, the SMCT system 40 executing a responsive action (e.g., tracking the unauthorized session or executing an action against the piracy actor) if the streaming session is determined to be unauthorized.

Referring back to the reception operation 302, in some implementations, the reception operation 302 for receiving, from a media player, playback metrics may entail receiving the playback metrics from the media player in accordance with Common Media Client Data (CMCD) standard. For instance, the SMCT system 40 of FIG. 2 directly or indirectly receiving the playback metrics from the media player 14 in accordance with the CMCD standard.

In some implementations, the receiving of the playback metrics from the media player of reception operation 302 includes receiving, from the media player, a globally unique identifier (GUID) of the signing server used to sign and stream the at least the portion of the media content. For instance, the SMCT system 40 receiving the playback metrics from the media player 14 by receiving, from the media player 14, a GUID of the last signing server 20c used to sign and stream the at least the portion (e.g., at least a subset of the segments) of the media content being streamed (e.g., media content stream 8 of FIGS. 1 and 2) from the CDN 12 to the media player 14.

In some implementations, the receiving, from the media player, the GUID of the signing server used to sign and stream the at least the portion of the media content to the media player includes receiving one or more GUIDS of one or more other signing servers used to sign and stream the at least the portion of the media content from a content origin to the media player. For instance, the SMCT system 40 receiving, from the media player 14, the GUID of the signing server 20c used to sign and stream the at least the portion (e.g., at least a subset of the segments) of the media content to the media player 14 includes receiving one or more GUIDS of one or more other signing servers (e.g., signing servers 20a and 20b of FIG. 1) used to sign and stream the at least the portion of the media content from a content origin 10 to the media player 14.

In some implementations, the determination as to whether the streaming session is an unauthorized streaming session includes determining whether the signing server and the one or more other signing servers used to sign and stream the at least the portion of the media content from a content origin to the media player are an appropriate combination of signing servers for signing and streaming the at least the portion of the media content to the media player. For instance, the SMCT system 40 determining whether the streaming session is an unauthorized streaming session by determining whether the signing server (e.g., the signing server 20c of FIG. 1) and the one or more other signing servers (e.g., signing servers 20a and 20b) used to sign and stream the at least the portion of the media content from a content origin 10 to the media player 14 are an appropriate combination of signing servers for signing and streaming the at least the portion (e.g., subset of segments) of the media content to the media player 14. In various embodiments, the GUIDs associated with the signing servers 20a, 20b, and 20c that were signed on the at least the portion of the media content may be examined to confirm that they appear to have been signed in the correct sequential order that would normally occur as the media content traverses through the CDN 12 from the content origin 10 to the media player 14. If the GUIDs appear out of order, missing, or in a sequence inconsistent with legitimate routing, the session may be determined to be unauthorized, as such anomalies may indicate tampering or an attempt to disguise piracy activity.

In some cases, the basis for determining whether the signing servers (e.g., signing servers 20a, 20b, and 20c of FIG. 1) are the appropriate servers is provided through the C2PA-signed manifest, which includes the associated provenance information. The manifest defines the expected binding metadata, including the streaming session identifiers, the signing server assignments, and the sequential order in which segments are to be signed and delivered. This provenance information effectively serves as the authoritative reference, allowing the SMCT system 40 to validate that the combination of signing servers—and the order in which they appear—corresponds to what is expected for a given media player location.

Accordingly, rather than relying solely on an external database, the SMCT system 40 may use the signed manifest as the cryptographically verifiable source of truth. The C2PA provenance records (GUIDs) embedded in the manifest, in combination with playback metrics reported from the media player 14, allow the SMCT system 40 to confirm that the signing path (e.g., the CDN route that the media content stream takes) aligns with the legitimate CDN delivery model. Any deviation in the combination or order of signing servers, relative to the manifest's provenance information, may therefore be treated as evidence of an unauthorized or tampered streaming session.

In some implementations, the determination of whether the one or more other signing servers 20a and 20b that was used to sign and stream the at least the portion of the media content are appropriate signing servers may be based on a determination of whether the one or more other signing servers 20a and 20b as well as the singing server 20c would normally be used to sign and stream at least a subset of the segments of the media content to the media player 14 under the specific circumstances including based, at least in part, on the location of the media player 14 and the locations of the signing servers 20a, 20b, and 20c of the CDN 12, and if not, execute a responsive action.

In some implementations, the media content to be streamed to the media player during the streaming session is video content. For example, in some cases the media content is video on demand (VOD), or a portion thereof. Examples of VOD includes a movie, a television program that may or may not include ads, documentary, a recorded seminar, and so forth. In some alternative implementations, the media content to be streamed to the media player during the streaming session is live-stream video.

In various implementations, the determination operation 304 of process 300 of FIG. 1 may be implemented in a variety of different ways. For example, in some implementations, the determination as to whether the signing server is an appropriate signing server for signing and streaming the at least the portion of the media content includes determining whether the signing server is last signing server of the CDN to sign and stream the at least the portion of the media content from the CDN to the media player, and if so, whether the signing server should be the last signing server of the CDN to sign the at least the portion of the media content based, at least in part, on the media player location. For instance the SMCT 40 determining whether the signing server 20c is an appropriate signing server for signing and streaming the at least the portion of the media content includes determining, by the SMCT 40, whether the signing server 20c is the last signing server of the CDN 12 to sign (e.g., tag with the GUID associated with the signing server 20c) and stream the at least the portion of the media content from the CDN 12 to the media player 14, and if so, whether the signing server 20c should be the last signing server of the CDN 12 to sign the at least the portion of the media content based on the media player location.

Referring back to the execution operation 306 of FIG. 3, the execution operation may be implemented in a variety of different ways. For example, in some implementations, the responsive action may include generating an alert or flag indicating that the streaming session is unauthorized. For instance, the SMCT system 40 executing the responsive action by generating an electronic alert or flag and electronically transmitting the alert or flag to a user device (e.g., a computing device of an administrator) indicating that the streaming session is unauthorized (e.g., a piracy activity).

In some implementations, the responsive action includes automatically terminating the streaming session if the stream session is determined to be an unauthorized streaming session. For instance, the SMCT system 40 executing the responsive action by automatically terminating the streaming session if the stream session is determined to be an unauthorized streaming session (e.g., act of piracy).

In some implementations, the responsive action includes recording the streaming session as an unauthorized session. For instance, the SMCT system 40 executing the responsive action by recording the unauthorized streaming session for potentially taking subsequent actions. Specifically, recording may serve as an alternative to immediate termination, permitting the system operator to maintain evidence of piracy-related activity for subsequent enforcement or forensic analysis. That is, in some embodiments, the recording or tracking of the unauthorized streaming session may be used where an operator does not immediately terminate the streaming session, but instead, records the unauthorized activity as a basis for later enforcement. For example, the SMCT system 40 may maintain logs of repeated unauthorized sessions associated with a particular user account, device, or corporate network. Such records can then be used to take action at a later time, such as suspending service, denying future access, or initiating enforcement proceedings against a particular user or company identified as engaging in piracy.

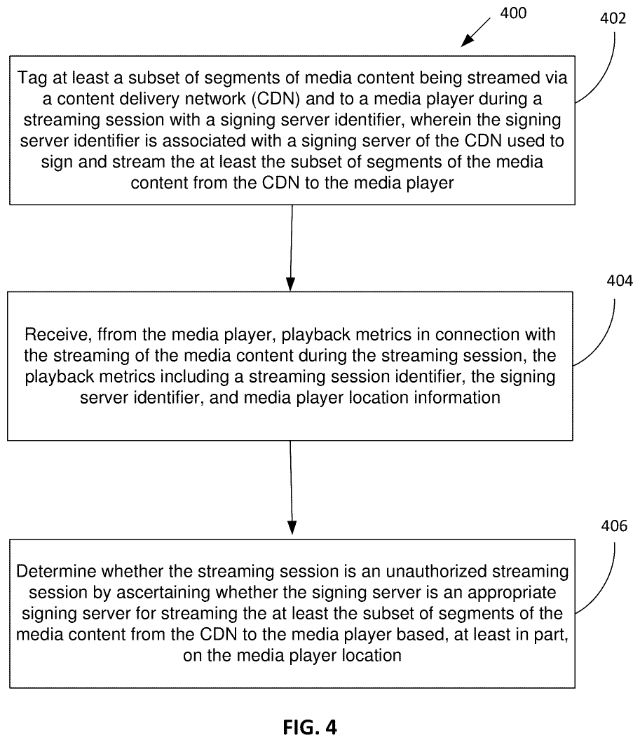

FIG. 4 is another flowchart of another example process 400 for determining whether a media content streaming session is an unauthorized streaming session according to various implementations. In some implementations, at least some of the operations illustrated in FIG. 4 may be performed by the streaming media content tracking (SMCT) system 40 of FIG. 2. For case of illustration and to facilitate understanding of process 400, the following discussion of process 400 will reference the systems and features illustrated in FIGS. 1 and 2. However, those of ordinary skill in the art will recognize that process 400 may be implemented using systems and features other than those illustrated in FIGS. 1 and 2.

In various implementations, the process 400 may begin when a tagging operation 402 is executed for tagging at least a subset of segments of media content being streamed via a content delivery network (CDN) and to a media player during a streaming session with a signing server identifier, wherein the signing server identifier is associated with a signing server of the CDN used to sign and stream the at least the subset of segments of the media content from the CDN to the media player. For instance, the SMCT system 40 of FIG. 2, via signing server 20c for example, tagging at least a subset of segments of media content being streamed via a CDN 12 and to a media player 14 during a streaming session with a signing server identifier (e.g., a signing server GUID), wherein the signing server identifier is associated with, for example, the last signing server 20c of the CDN 12 used to tag (e.g., sign) and stream the at least the subset of segments of the media content from the CDN 12 to the media player 14.

In various embodiments, the GUIDs used in the SMCT system 40 correspond to the C2PA manifest identifiers, which function as provenance records. These GUIDs may be hashed and signed in accordance with the C2PA standard, and then associated with individual segments of media content. As noted above, in some embodiments, the GUIDs are inserted directly into the segments (e.g., into the MOOV atom of an fMP4 container) so that each signed segment cryptographically carries its own provenance binding. This approach allows segment-level validation, since the GUID embedded in the segment is protected by the cryptographic hash and digital signature contained in the C2PA manifest.

In alternative embodiments, rather than embedding the GUID into each segment payload, the GUID may be bound to the segment through external manifest metadata. In this case, the manifest includes the provenance information, streaming session identifier, and signing server identifiers, with digests that cover the corresponding segments. The CMCD log repository 44 can then correlate playback metrics and reported GUIDs from the media player with the manifest entries to confirm that each segment played matches its signed provenance record.

Thus, whether carried directly in the segment container or bound externally through manifest metadata, the GUID serves as the C2PA provenance record identifier that is cryptographically signed and hashed, ensuring that each segment can be independently verified as authentic and untampered.

Note that a GUID associated with a signing server, such as the GUID of the signing server 20c described above, does not uniquely identify the signing server itself, nor does it always need to be inserted into a segment as noted above. Instead, the GUID functions as the C2PA provenance record identifier contained within the manifest, which cryptographically binds the segment to its provenance information. The provenance metadata in the manifest may include multiple components, such as the streaming session identifier, segment identifier, and the identifier[s] of the signing server[s] involved in delivery of the media content. In some embodiments, the GUID from the manifest may be inserted directly into the segment container (e.g., the MOOV atom of an fMP4) so that the segment itself carries the cryptographically bound reference. In other embodiments, the GUID remains in the C2PA-signed manifest, which contains the hash of the segment along with its associated provenance metadata (including the signing server), thereby providing the binding externally without modifying the segment. In both cases, the cryptographic binding is achieved by hashing the segment, embedding the digest into the manifest alongside the provenance information, and digitally signing the manifest. This ensures that each segment is verifiably associated with its C2PA provenance record, of which the signing server identifier is one element of the metadata rather than the GUID itself.

As noted above, as a segment of a media content traverses through the CDN 12, it will be signed by each signing server 20* it encounters. Thus, by the time media content segment leaves the CDN 12, many signing server 20* may have signed (e.g., tagged) the segment.

Process 400 may also include a reception operation 404 for receiving, from the media player, playback metrics associated with the streaming of the media content during the streaming session, the playback metrics including a streaming session identifier, the signing server identifier, and media player location information. For instance, the SMCT system 40 of FIG. 2 receiving, from the media player 14, playback metrics associated with the streaming of the media content during the streaming session, the playback metrics including a streaming session identifier (e.g., the streaming session GUID generated by, for example, the provenance record generator 42), the signing server identifier (e.g., the GUID of the signing server 20c generated by, for example, the provenance record generator 42), and media player location information (e.g., IP address). In some cases, the streaming session identifier may have been tagged to the subset of segments by the content origin 10 as part of providence information, or alternatively, by a signing server, such as signing server 20a.

Process 400 may further include a determination operation 406 for determining whether the streaming session is an unauthorized streaming session by ascertaining whether the signing server is an appropriate signing server for streaming the at least the subset of segments of the media content from the CDN to the media player based, at least in part, on the media player location. For instance, the SMCT system 40 of FIG. 2 determining whether the streaming session ((which may involve streaming of a live event, a VOD, ad or commercial, and so forth) is an unauthorized streaming session by ascertaining whether the signing server 20c is an appropriate signing server for streaming the at least the subset of segments of the media content (e.g., media content stream 8 of FIGS. 1 and 2) from the CDN 12 to the media player 14 based, at least in part, on the media player location. For example, if the signing server 20c is determined to be the “nearest” to the media player location, among the signing servers 20* of the CDN 12, then ascertaining that the signing server 20c is the appropriate signing server, and if not, ascertaining that the signing server 20c is not the appropriate signing server for streaming the at least the subset of segment of the media content.

Note that the term “nearest” relative to the media player location described above is not limited strictly to physical geography. Instead, it refers to the most appropriate signing server in relation to the media player's location and the CDN topology. This can be evaluated in different ways:
Geographically nearest—the signing server that is physically closest to the media player's IP-resolved location.
Network/data path nearest—the signing server that is topologically closest in terms of routing efficiency, latency, or CDN assignment, which may differ from geographic distance.

The determination of the “appropriate” signing server under C2PA provenance does not rely on one single definition of “nearest.” Instead, the C2PA-signed manifest and provenance records reflect the server assignment that the CDN makes for that session, ensuring that whichever server is selected (geographic or path-based) is cryptographically bound into the provenance chain. Thus, “nearest,” as used herein, should be understood more broadly as the server that the CDN designates as the most appropriate for delivery, whether by geography, network routing, or load-balancing policy, and not just physical proximity.

Referring back to the tagging operation 402, in some implementations, the segments of the media content are fragmented MP4 (fMP4) segments, and the tagging by, for example, a signing server 20a, 20b, or 20c the subset of the segments of media content the signing server identifier (e.g., a GUID assigned to the signing server 20a, 20b, or 20c by the provenance record generator 42) and, and in some cases the tagging of the streaming session identification (e.g., a GUID assigned to the streaming session by the provenance record generator 42) includes inserting, by the signing server 20a, 20b, or 20c, inserting the identifiers into the payloads of the at least the subset of segments.

In some implementations, the signing server identifier to be tagged to the subset of segments is a globally unique identifier (GUID) for the signing server (e.g., the signing server 20a, 20b, or 20c of FIG. 1).

In some implementations, each of the subset of segments of the media content may be tagged with their respective GUID. For example, one of the signing servers 20a, 20b, and 20c along the CDN deliver path, such as signing server 20a, tagging each of the subset of segments of the media content with their respective GUID (e.g., signing server 20a's GUID). For these implementations, the provenance record generator 42 may generate the respective GUID of a segment by performing a hashing operation on the segment, and using the resulting digest as the GUID.

In some implementations, tagging the at least a subset of segments of media content being streamed with the signing server identifier includes inserting the signing server identifier into a manifest of the media content. For instance, one of the signing server 20a, 20b, or 20c of SMCT system 40 inserting the signing server identifier into a manifest of the media content.

In various implementations, per-segment binding approach may be employed where each media content segment (the moof/mdat of the segment) to be signed can be independently hashed and its digest recorded in the C2PA manifest. The manifest, in turn, is signed, creating cryptographic binding between the provenance record and each segment. Thus, under this approach, the segments are cryptographically associated with provenance records via hashes listed in the signed C2PA manifest.

In some implementations, the tagging of at least a subset of segments of media content with a signing server identifier includes tagging at least the subset of segments of the media content with a GUID of the signing server. For instance, a signing server 20c of the SMCT system 40 of FIG. 2 tagging at least a subset of segments of media content with a signing server identifier includes tagging at least the subset of segments of the media content (e.g., VOD or live-stream media) with a GUID of the signing server 20c.

In some implementations, the tagging of the at least the subset of segments of the media content with the GUID of the signing server includes inserting the GUID of the signing server into the subset of segments. For instance, the signing server 20c of the SMCT system 40 of FIG. 2 inserting the GUID of the signing server 20c into the subset of segments.

In some implementations, the tagging of the at least the subset of segments of the media content with the GUID of the signing server includes inserting the GUID of the signing server into a media content manifest.

In some implementations, the tagging of the at least the subset of segments of the media content with the GUID of the signing server includes tagging the at least the subset of the segments of media content with one or more GUIDs of one or more other signing servers, respectively, used to sign and stream the at least the subset of segments through the CDN. For instance, the signing server 20c of the SMCT system 40 of FIG. 2 tagging the at least the subset of segments of the media content with the GUID of the signing server by having the signing servers 20a and 20b also tag the at least the subset of the segments of media content with the respective GUIDs of the signing servers 20a and 20b that are used to sign and stream the at least the subset of segments through the CDN 12.

In some implementations, the tagging of the at least the subset of the segments of media content with the GUID of the signing server and the one or more GUIDs of one or more other signing servers includes inserting the GUIDs of the signing server and the one or more other signing servers into the subset of segments. For instance, the singing servers 20a, 20b, and 20c of FIG. 1 tagging the at least the subset of the segments of media content with the GUID of the signing server 20c and the respective GUIDs of the signing servers 20a and 20b by having the signing server 20c insert its GUID into the subset of segments and having the signing servers 20a and 20b insert their respective GUIDs into the subset of segments.

In some implementations, the tagging of the at least the subset of the segments of media content with the GUID of the signing server and the one or more GUIDs of one or more other signing servers includes inserting the GUIDs of the signing server and the one or more other signing servers into a media content manifest. For instance, the singing servers 20a, 20b, and 20c of FIG. 1 tagging the at least the subset of the segments of media content with the GUID of the signing server 20c and the respective GUIDs of the signing servers 20a and 20b by having the signing server 20c insert its GUID into a media content manifest and having the signing servers 20a and 20b insert their respective GUIDs into the media content manifest.

As noted above, the frequency in which streaming segments of a media content are signed or tagged with GUIDs may be increased or decreased depending on circumstances. Frequency, as used herein, relates to how frequently the streaming segments of media content are being tagged. For example, tagging every other, every third, every fourth, and so forth of the media content segments being streamed. In some cases, the frequency of signing or tagging of streaming segments may be higher at the beginning of media content file to quickly detect piracy, while subsequently reduced later on to reduce latency and computational requirements.

Specifically, in some implementations, the tagging of at least a subset of segments of media content being streamed during a streaming session with a signing server identifier includes tagging the signing server identifier to a first subset of segments of the steaming media content at a first frequency, and then tagging the signing server identifier to a second subset of segments of the steaming media content at a second frequency, wherein the first subset of segments are streamed to the media player before the second subset of segments, and wherein the first frequency is higher than the second frequency. For instance, each of the signing servers 20a, 20b, and 20c of FIG. 1 tagging their respective signing server identifier (e.g., GUID) with a first subset of segments of the steaming media content at a first frequency (e.g., tag every other segment), and then tagging the signing server identifier to a second subset of segments of the steaming media content at a second frequency (e.g., tag every fourth or fifth segment), wherein the first subset of segments are streamed to the media player before the second subset of segments, and wherein the first frequency is higher than the second frequency.

In some implementations, the at least a subset of segments of media content are tagged with a globally unique identifier (GUID) associated with the streaming session. For instance, the at least the subset of segments of media content to be tagged were previously tagged with a GUID associated with the streaming session or are tagged by the SMCT 40. In some cases, the GUID for the streaming session may be tagged to the subset of segments by the content origin 10 or by the SMCT 40 of FIG. 1 such as, for example one of the signing servers 20a, 20b, and 20c along their CDN delivery path.

Referring to the reception operation 404 of FIG. 4, in some implementations, the playback metrics are received in accordance with a Common Media Client Data (CMCD) standard.

In some implementations, the receiving of the playback metrics includes receiving a globally unique identifier (GUID) associated with the signing server used to sign and stream the subset of segments from the CDN to the media player. For instance, the SMCT system 40 of FIG. 2 receiving the playback metrics including receiving a GUID associated with the last signing server 20c used to sign and stream the subset of segments from the CDN 12 to the media player 14.

In some implementations, the receiving of the GUID associated with the signing server includes receiving one or more GUIDs, respectively, of one or more other signing servers used to sign and stream the subset of segments through the CDN, For instance the SMCT system 40 of FIG. 2 receiving the GUID associated with the signing server 20c along with the respective GUIDs of the other signing servers 20a and 20b used to sign and stream the subset of segments through the CDN 12.

Referring back to the determination operation 406 of FIG. 4, in some implementations, the determination as to whether the streaming session is unauthorized includes ascertaining whether the signing server and the one or more other signing servers are an appropriate combination of signing servers for the streaming session based, at least in part, on the media player's location. For instance, the SMCT system 40 determining whether the streaming session is unauthorized by ascertaining whether the signing server 20c and the other signing servers 20a and 20b are an appropriate combination of signing servers for the streaming session based, at least in part, on the media player's location and, in some cases, the network topography of the CDN 12.

The determination of whether a particular combination of signing servers 20* is appropriate for a particular session may not be based solely on the geographic or network proximity of the media player 14 and content origin 10. While location is one factor, the SMCT system 40 may also evaluate additional session metadata that is captured and cryptographically bound within the C2PA provenance manifest. This includes CDN access tokens that verify the authorized delivery path, DRM license identifiers that confirm playback rights, and session-level data such as user entitlements, playback device identifiers, service-level policies (e.g., regional blackout rules), and quality-of-service markers (e.g., bitrate adaptation or delivery tier). By binding these elements to the manifest, a verifiable record may be created demonstrating not only that the signing servers that were use to sign and stream the media content, such as signing servers 20a, 20b, and 20c of FIG. 1, were geographically or logically appropriate, but also that they complied with the full set of routing, rights management, and service policy rules applicable to that specific streaming session.

In some implementations, wherein determining whether the signing server is an appropriate signing server includes ascertaining whether the signing server is last, among a plurality of signing servers of the CDN to sign the subset of segments before the subset of segments are streamed from the CDN to the media player, and if so, ascertaining whether the signing server should be the last signing server of the CDN to sign the subset of segments based, at least in part, on the location of the media player. For instance, the SMCT system 40 determining whether the signing server 20c is an appropriate signing server includes ascertaining whether the signing server 20c is last, among a plurality of signing servers 20* of the CDN 12 to sign the subset of segments before the subset of segments are streamed from the CDN 12 to the media player 14, and if so, ascertaining whether the signing server 20c should be the last signing server of the CDN 12 to sign the subset of segments based, at least in part, on the location of the media player 14.

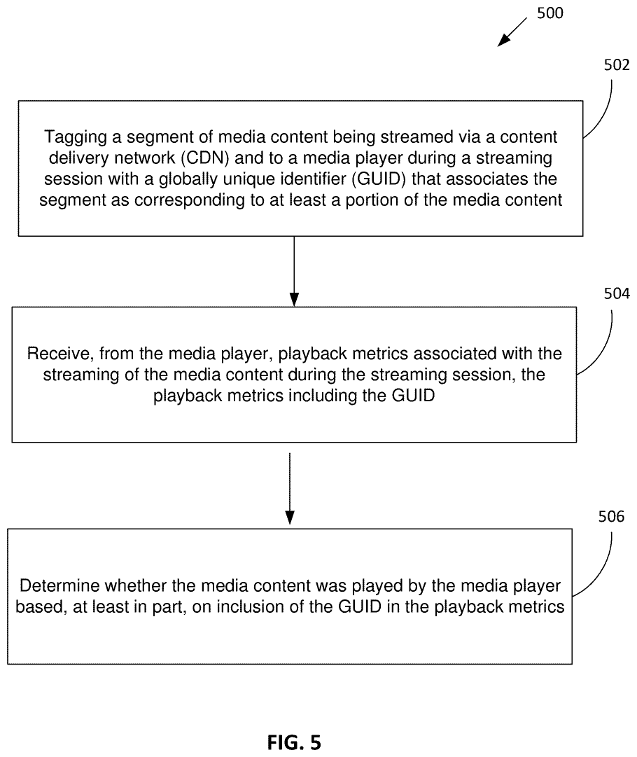

FIG. 5 is a flow chart of an example process 500 for determining whether a media content was played by a media player based on a reception from the media player of a GUID of a segment of the media content according to various implementations. In some implementations, at least some of the operations illustrated in FIG. 5 may be performed by the SMCT system 40 of FIG. 2. For case of illustration and to facilitate understanding of process 500, the following discussion of process 500 will reference the systems and features illustrated in FIGS. 1 and 2. However, those of ordinary skill in the art will recognize that process 500 may be implemented using systems and features other than those illustrated in FIGS. 1 and 2.

In various implementations, the process 500 may begin when a tagging operation 502 is performed that tags a segment of media content being streamed via a content delivery network (CDN) and to a media player during a streaming session with a globally unique identifier (GUID) that associates the segment as corresponding to at least a portion of the media content. For instance, the SMCT system 40, such as one of the signing servers 20* of the SMCT system 40 or the content origin 10, which may be a computing device such as a server, tagging a segment of media content being streamed via a CDN 12 and to a media player 14 during a streaming session with a GUID that associates the segment as corresponding to at least a specific portion or part of the media content (e.g., corresponding to the 10-second point of a 30-second video file such as an ad).

Process 500 may also include a reception operation 504 for receiving, from the media player, playback metrics in connection with the streaming of the media content during the streaming session, the playback metrics including the GUID. For instance, the SMCT system 40 receiving directly or indirectly from the media player 14, playback metrics in connection with the streaming of the media content during the streaming session, the playback metrics including the GUID. In some implementations, the playback metrics may be received in accordance with the CMCD standard. In some cases, the GUID that may be part of the playback metrics may be used to identify where in the media content the segment belongs to. For example, suppose the segment represents a five-second portion of the media content, and if the media content is a 30-second public announcement, the GUID when looked up by the CMCD log repository 44, is able to determine that the segment corresponds to the 15-20 second portion of the 30-second media content.

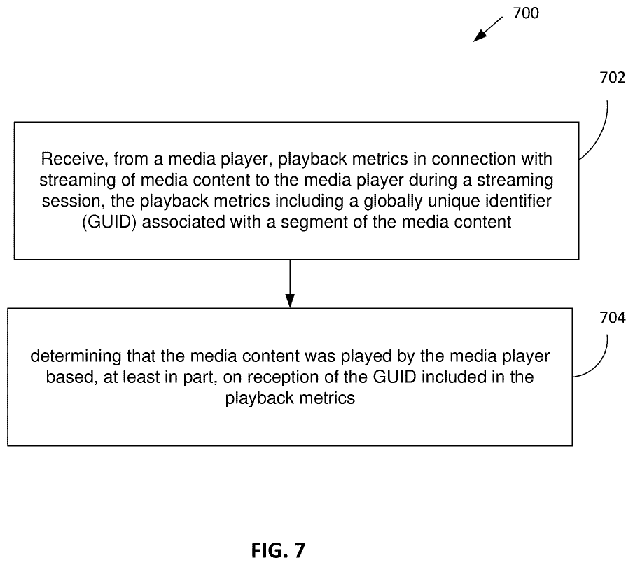

Process 500 may also include a determination operation 506 for determining that the media content was played by the media player based, at least in part, on the reception of the GUID included in the playback metrics. For instance, the SMCT system 40 of FIG. 2 determining (e.g., concluding) that the media content was played by the media player 14 based, at least in part, on the reception of the GUID included in the playback metrics. Note that in various alternative implementations, the tagging operation 502 may be omitted, as will be discussed below with reference to process 700 of FIG. 7 since the tagging operation 502 may be independently implemented by a separate system other than the one that implements operations 504 and 506. For example, the content origin 10 may implement the tagging operation 502, while the reception operation 504 and the determination operation 506 may be implemented by the SMCT system 40 of FIG. 2.

In some implementations, the video content to be streamed may be a movie, a documentary, a documentary, a television program, a live stream event, an advertisement or a commercial, and so forth.

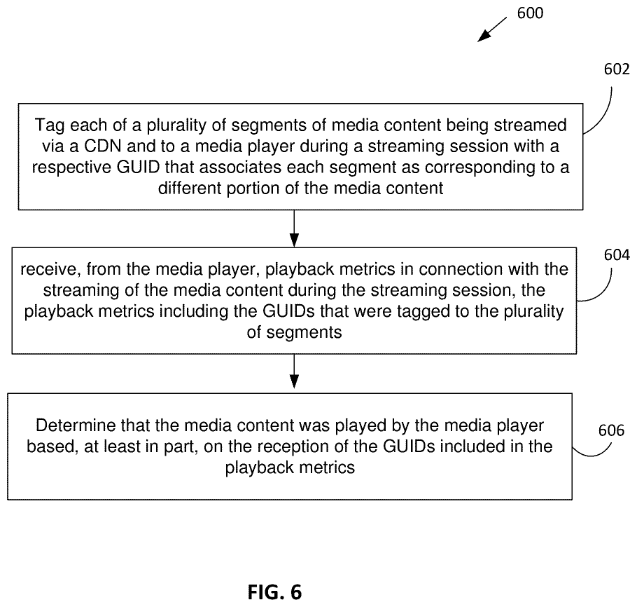

In various alternative implementations, the determination as to whether the media content was played by the media player may be based on the reception from the media player of multiple respective GUIDs of multiple segments of the media content. This strategy of, in essence, verifying that multiple segments of a media content (e.g., a video file such as documentary, and, public announcement, and so forth) was played is a more reliable way of determining that the entire media content was played by the media player. Referring now to FIG. 6, which is a flow chart of an example process 600 determining whether a media content was played by a media player based on a reception from the media player of multiple respective GUIDs of multiple segments of the media content according to various implementations. In some implementations, at least some of the operations illustrated in

In some implementations, at least some of the operations illustrated in FIG. 6 may be performed by the SMCT system 40 of FIG. 2. For ease of illustration and to facilitate understanding of process 600, the following discussion of process 600 may reference the systems and features illustrated in FIGS. 1 and 2. However, those of ordinary skill in the art will recognize that process may be implemented using systems and features other than those illustrated in FIGS. 1 and 2. Further, certain details such as the process of tagging identifiers such as GUIDs to media content segments will be omitted since they were already discussed above.

In various implementations, process 600 may begin when a tagging operation 602 is performed for tagging each of a plurality of segments of media content being streamed via a content delivery network (CDN) and to a media player during a streaming session with a respective globally unique identifiers (GUID) that associate each segment as corresponding to a different portion of the media content. For instance, one of the signing servers 20* of the SMCT system 40 of FIG. 2 (or the content origin 10) tagging each of a plurality of segments of media content being streamed via a CDN 12 and to a media player 14 during a streaming session with respective a GUID that associate each segment as corresponding to a different portion of the media content. More particularly, each segment to be tagged will be tagged with its own GUID that corresponds to a specific part of the media content.

Process 600 may also include a reception operation 604 for receiving, from the media player, playback metrics in connection with the streaming of the media content during the streaming session, the playback metrics including the GUIDs that were tagged to the plurality of segments. For instance, the SMCT system 40 of FIG. 2 receiving, from the media player 14, playback metrics in connection with the streaming of the media content during the streaming session, the playback metrics including the GUIDs that were tagged to the plurality of segments.

Finally, process 600 may further include a determination operation 606 for determining that the media content was played by the media player based, at least in part, on the reception of the GUIDs included in the playback metrics. For instance, the SMCT system 40 of FIG. 2 determining (e.g., concluding) that the media content was played by the media player 14 based, at least in part, on the reception of the GUID included in the playback metrics.

FIG. 7 is a flow chart of another example process 700 for determining whether a media content was played by a media player based on a reception from the media player of a GUID of a segment of the media content according to various implementations, like process 500 of FIG. 5. However, unlike process 500 there is no tagging operation 502. In some implementations, the operations illustrated in FIG. 7 may be performed by the SMCT system 40 of FIG. 2. For case of illustration and to facilitate understanding of process 500, the following discussion of process 500 will reference the systems and features illustrated in FIGS. 1 and 2. However, those of ordinary skill in the art will recognize that process 500 may be implemented using systems and features other than those illustrated in FIGS. 1 and 2.

In various implementations, the process 700 may begin when a reception operation 702 is performed for receiving, from a media player, playback metrics in connection with streaming of media content to the media player during a streaming session, the playback metrics including a GUID associated with a segment of the media content. For instance, the SMCT system 40 of FIG. 2 receiving, directly or indirectly, from a media player 14 and in accordance with CMCD standard, playback metrics in connection with streaming and playing of media content to and by the media player 14 during a streaming session, the playback metrics including a GUID associated with a segment of the media content 14.

As further illustrated, process 700 may also include a determination operation 704 for determining that the media content was played by the media player based, at least in part, on reception of the GUID included in the playback metrics. For instance, the SMCT system 40 of FIG. 2 determining (e.g., concluding) that the media content was played by the media player based, at least in part, on reception of the GUID included in the playback metrics.

In various alternative implementations, and as previously noted with respect to process 600 of FIG. 6, the determination as to whether the media content was played by the media player may be based on the reception from the media player of multiple respective GUIDs of multiple segments of the media content. This strategy of, in essence, verifying that multiple segments of a media content (e.g., a video file such as documentary, and, public announcement, and so forth) was played is a more reliable way of determining that the entire media content was played by the media player.

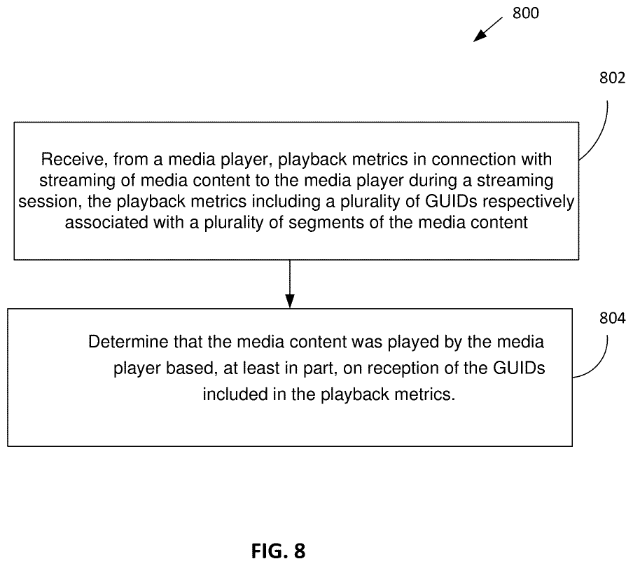

Referring now to FIG. 8, which is a flow chart of an example process 800 determining whether a media content was played by a media player based on a reception from the media player of multiple respective GUIDs of multiple segments of the media content according to various implementations. Note that process 800 is similar to the process 600 of FIG., but without a tagging operation such as the tagging operation 602 of FIG. 6. In some implementations, at least some of the operations illustrated in FIG. 8 may be performed by the SMCT system 40 of FIG. 2. For case of illustration and to facilitate understanding of process 600, the following discussion of process 800 may reference the systems and features illustrated in FIGS. 1 and 2. However, those of ordinary skill in the art will recognize that process 800 may be implemented using systems and features other than those illustrated in FIGS. 1 and 2. Further, certain details such as the process of tagging identifiers such as GUIDs to media content segments will be omitted since they were already discussed above.

In various implementations, process 800 may include a reception operation 802 for receiving, from a media player, playback metrics in connection with streaming of media content to the media player during a streaming session, the playback metrics including a plurality of GUIDs respectively associated with a plurality of segments of the media content. For instance, the e SMCT system 40 of FIG. 2 receiving directly or indirectly, from a media player 14, playback metrics in connection with streaming of media content to the media player 14 during a streaming session, the playback metrics including a plurality of GUIDs respectively associated with a plurality of segments of the media content (e.g., each received GUID associated with a respective segment of the plurality of segments).

Process 800 may also include a determination operation 804, similar to the determination operation 606 of FIG. 6, for determining that the media content was played by the media player based, at least in part, on reception of the GUIDs included in the playback metrics. For instance, the SMCT system 40 of FIG. 2 determining (e.g., concluding) that the media content was played by the media player 14 based, at least in part, on reception of the GUIDs included in the playback metrics.

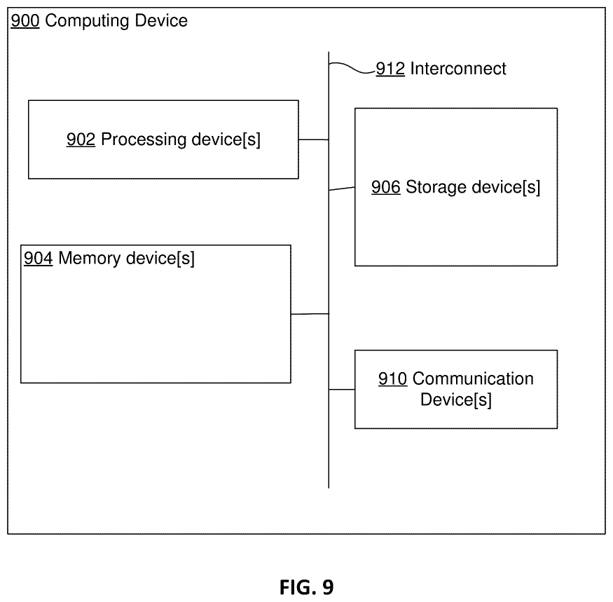

FIG. 9 is a high-level block diagram of an example computing device 900 in accordance with some example embodiments. In various embodiments, a plurality of the computing devices 900 may be employed to implement the SMCT system 40 of FIG. 2. For example, multiple instances of the computing device 900 can be used to implement the signing servers 20*, the provenance record generator 42, and the log repository 44 in various implementations.

As illustrated, the computing device 900 includes one or more processing devices 902, one or more memory devices 904, one or more storage devices 906, and one or more communication devices 910, all coupled together via an interconnect 912. In various implementations, at least some of the processes and logic flows described above can be performed by the one or more processing devices 902 executing one or more computer programs. For example, when a signing server 20* of FIG. 1 is implemented at least partly via a computer program rather than via dedicated circuits such as ASIC, a computer program, which may be loaded on the one or more memory devices 904, may be executed by the one or more processing devices 902 to execute the above-described techniques for tagging media content segments with GUIDs. Note that although not explicitly illustrated in FIG. 9, a persistent copy of the computer program may be stored in one or more storage devices 906.

The interconnect 912 may be or include one or more conductive traces, buses, point-to-point connections, controllers, adapters, and/or other connection devices. The one or more processing devices 902 may include, for example, one or more processors, digital signal processors (DSPs), controllers, field programmable gate array (FPGA), application specific integrated circuit (ASIC), or the like, or any combination thereof. The one or more memory devices 904 may include one or more physical storage devices, which may be in the form of random-access memory (RAM), Static RAM (SRAM), Dynamic RAM (DRAM), read-only memory (ROM), flash memory, or other suitable type of storage or memory device, or a combination of such devices. The one or more storage devices 906 may include one or more hard drives, solid-state drives, digital versatile disks (DVDs), flash memories, datastore, or the like. Each of the memory device[s] 904 and/or storage device[s] 906 may store, individually or collectively, data and instructions that configure the one or more processing devices 902 to execute operations to implement some of the processes and operations described above.

The one or more communication devices 910 may include, for example, a network interface card (NIC), an Ethernet adapter, cable modem, Wi-Fi adapter, cellular transceiver, baseband processor, or the like, or a combination thereof.

After reviewing the present disclosure, an individual of ordinary skill in the art will immediately appreciate that some details and features can be added, removed and/or changed without deviating from the spirit of the invention. Reference throughout this specification to “one implementation,” “an implementation,” “additional implementation(s)” or “some implementations,” means that a particular feature, structure or characteristic described in connection with the implementation(s) is included in at least one or some implementation(s), but not necessarily all implementations, such that the references do not necessarily refer to the same implementation(s). Furthermore, the particular features, steps, structures, or characteristics may be combined in any suitable manner in one or more implementations. These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled.

1. A computer-implemented method, comprising:
receiving, from a media player, playback metrics in connection with streaming of a media content to the media player during a streaming session, the playback metrics including a streaming session identifier and media player location information; and
determining whether the streaming session is an unauthorized streaming session by ascertaining whether a signing server of a content delivery network (CDN) used to stream at least a portion of the media content from the CDN to the media player during the streaming session is an appropriate signing server for signing and streaming the at least the portion of the media content from the CDN to the media player based on the media player location derived from the media player location information.

2. The computer-implemented method of claim 1, wherein the playback metrics are received directly or indirectly from the media player in accordance with a Common Media Client Data (CMCD) standard.

3. The computer-implemented method of claim 1, wherein receiving the playback metrics includes receiving a globally unique identifier (GUID) of the signing server used to sign and stream the at least the portion of the media content.

4. The computer-implemented method of claim 3, wherein receiving the GUID includes receiving one or more respective GUIDs of one or more other signing servers used to sign and stream the at least the portion of the media content from a content origin to the media player.

5. The computer-implemented method of claim 4, wherein determining whether the streaming session is unauthorized includes determining whether the signing server and the one or more other signing servers are an appropriate combination of signing servers for signing and streaming the at least the portion of the media content to the media player. (based on media player location and deviation from an expecting routing to the media player in the most efficient manner—whether the signing servers and the one or more other signing servers signed the at least the portion of the media content in the proper order relative the media play er location).

6. The computer-implemented method of claim 1, wherein determining whether the signing server is an appropriate signing server for signing and streaming the at least the portion of the media content includes determining whether the signing server is last signing server of the CDN to sign and stream the at least the portion of the media content from the CDN to the media player, and if so, whether the signing server should be the last signing server of the CDN to sign the at least the portion of the media content based on the media player location.

7. The computer-implemented method of claim 1, further comprising executing a responsive action if the streaming session is determined to be unauthorized.

8. A computer-implemented method, comprising:
tagging at least a subset of segments of media content being streamed via a content delivery network (CDN) and to a media player during a streaming session with a signing server identifier, wherein the signing server identifier is associated with a signing server of the CDN used to sign and stream the at least the subset of segments of the media content from the CDN to the media player;
receiving, from the media player, playback metrics associated with the streaming of the media content during the streaming session, the playback metrics including a streaming session identifier, the signing server identifier, and media player location information; and
determining whether the streaming session is an unauthorized streaming session by ascertaining whether the signing server is an appropriate signing server for streaming the at least the subset of segments of the media content from the CDN to the media player based, at least in part, on the media player location.

9. The computer-implemented method of claim 8, wherein tagging at least a subset of segments of media content with a signing server identifier includes tagging at least the subset of segments of the media content with a globally unique identifier (GUID) of the signing server.

10. The computer-implemented method of claim 9, wherein tagging the at least the subset of segments of the media content with the GUID of the signing server includes inserting the GUID of the signing server into the subset of segments.

11. The computer-implemented method of claim 9, wherein tagging the at least the subset of segments of the media content with the GUID of the signing server includes inserting the GUID of the signing server into a media content manifest.

12. The computer-implemented method of claim 9, wherein tagging the at least the subset of segments of the media content with the GUID of the signing server includes tagging the at least the subset of the segments of media content with one or more GUIDs of one or more other signing servers, respectively, used to sign and stream the at least the subset of segments through the CDN.

13. The computer-implemented method of claim 12, wherein tagging the at least the subset of the segments of media content with the GUID of the signing server and the one or more GUIDs of one or more other signing servers includes inserting the GUIDs of the signing server and the one or more other signing servers into the subset of segments.

14. The computer-implemented method of claim 12, wherein tagging the at least the subset of the segments of media content with the GUID of the signing server and the one or more GUIDs of one or more other signing servers includes inserting the GUIDs of the signing server and the one or more other signing servers into a media content manifest.

15. The computer-implemented method of claim 8, wherein tagging at least a subset of segments of media content being streamed during a streaming session with a signing server identifier includes tagging the signing server identifier to a first subset of segments of the steaming media content at a first frequency, and then tagging the signing server identifier to a second subset of segments of the steaming media content at a second frequency, wherein the first subset of segments are streamed to the media player before the second subset of segments, and wherein the first frequency is higher than the second frequency.

16. The computer-implemented method of claim 8, wherein receiving the playback metrics includes receiving a globally unique identifier (GUID) associated with the signing server used to sign and stream the subset of segments from the CDN to the media player.

17. The computer-implemented method of claim 16, wherein receiving the GUID associated with the signing server includes receiving one or more GUIDs, respectively, of one or more other signing servers used to sign and stream the subset of segments through the CDN.

18. The computer-implemented method of claim 17, wherein determining whether the streaming session is unauthorized includes ascertaining whether the signing server and the one or more other signing servers are an appropriate combination of signing servers for the streaming session based, at least in part, on the media player's location.

19. The computer-implemented method of claim 8, wherein determining whether the signing server is an appropriate signing server includes ascertaining whether the signing server is last, among a plurality of signing servers of the CDN to sign the subset of segments before the subset of segments are streamed from the CDN to the media player, and if so, ascertaining whether the signing server should be the last signing server of the CDN to sign the subset of segments based, at least in part, on the location of the media player.

20. One or more non-transitory computer-readable storage media including instructions that, when executed by one or more processors, cause the one or more processors to perform the steps of:
tag at least a subset of segments of media content being streamed via a content delivery network (CDN) and to a media player during a streaming session with a signing server identifier, wherein the signing server identifier is associated with a signing server of the CDN used to sign and stream the at least the subset of segments of the media content from the CDN to the media player;
receive, from the media player, playback metrics associated with the streaming of the media content during the streaming session, the playback metrics including a streaming session identifier, the signing server identifier, and media player location information; and
determine whether the streaming session is an unauthorized streaming session by ascertaining whether the signing server is an appropriate signing server for streaming the at least the subset of segments of the media content from the CDN to the media player based, at least in part, on the media player location.
